(19) United States
(12) Patent Application Publication
(10) Pub. No.: US 2011/0041813 A1
(43) Pub. Date: Feb. 24, 2011

(54) SUPPLY DEVICE FOR INTERNAL COMBUSTION ENGINE

(75) Inventor: Jean-Pierre Gobled, Semur en Auxois (FR)

Correspondence Address: CANTOR COLBURN LLP, 20 Church Street, 22nd Floor, Hartford, CT, 06103, US

(73) Assignee: GLF TECHNOLOGIES, SEMUR EN AUXOIS (FR)

(21) Appl. No.: 12/680,114

(22) PCT Filed: Sep. 23, 2008
(86) PCT No.: PCT/EP2008/008211

§ 371 Date: Nov. 4, 2010

(30) Foreign Application Priority Data
Sep. 25, 2007 (FR) 0706757

(51) Int. Cl. F02G 5/00

(52) U.S. Cl. 123/557

(57) ABSTRACT

The invention relates to an internal combustion engine and in particular to a device and a method for improving the fuel supply of the engine in order to optimise the fuel consumption by a better combustion in the engine, to reduce the polluting exhaust gases and to increase the yield of the engine. The invention is based on the principle of a liquid fuel gasification and on the production of an optimal air-fuel mixture.

### FIELD OF THE INVENTION

The present invention relates to an internal-combustion engine, and in particular to a device and a method for improving the fuel supply to the engine in such a way as to optimize the consumption of fuel by better combustion within the engine, reduce harmful exhaust gases, and increase the efficiency of the engine.

### PRIOR ART

The problem of how to improve the combustion of fuel in an internal-combustion engine is currently a concern to all society. The reason is, any improvement in combustion increases the efficiency of the internal-combustion engine and reduces consumption, resulting in a reduction in direct costs. At the same time, the exhaust gases, and the contaminants present in these gases, are reduced, which is a great advantage to the environment.

LPG (Liquefied Petroleum Gas) engines are known to produce relatively clean exhaust gases, LPG being known as a clean fuel which gives better combustion. The price of LPG is also normally less than the price of the other fuels, which is another advantage for this type of fuel. However, LPG has certain drawbacks such as its energy value, which is less than the values of other fuels such as gasoline or diesel. The number of LPG distribution outlets is also less than the number of distribution outlets for gasoline or diesel.

In the past, there have already been proposals to create a fuel that combines certain advantages of LPG with the advantages of conventional fuels such as gasoline or diesel. Some of these proposals sought to gasify the fuel to some extent before sending it to the engine. The U.S. Pat. No. 6,155,239 (F. D. Dykstra) discloses a supply system for an internal-combustion engine in which the fuel tank is also used to create a fuel/air mixture. This mixture is obtained by using a bubble pan in the bottom of the fuel tank, through which the external air is drawn in. Sensors placed in the tube connecting the fuel tank to the engine measure the air/fuel ratio. On the basis of the measured values, a computer controls the amount of additional air added to the fuel/air mixture delivered to the fuel tank outlet. If the air/fuel ratio is too rich, external air is added to the mixture; if the ratio is too lean, liquid fuel is injected into the mixture.

The U.S. Pat. No. 3,800,768 (J. C. Rhodes et al.) describes a system for reducing the amount of certain harmful substances in the exhaust gases during startup and warmup of the engine. During these periods the engine carburetor is bypassed and the engine is supplied with a mixture of air and certain low-boiling gasoline components. This mixture is produced by passing external air through the gasoline inside the tank. After the engine has reached normal operating conditions, the engine is supplied with fuel by the carburetor.

The French patent FR 2 167 082 (Haas-Volkman) describes a system for improving the uniformity of the fuel/air mixture in such a way as to reduce harmful gases. In that system, an air/fuel mixture is added to the mixture created by the carburetor.

British patent application GB 2 042 076 (da Costa) discloses a system that enables an internal-combustion engine to run on an extremely lean mixture. In that application, this mixture can be produced by passing some of the external air through the fuel. The fuel is heated by a takeoff from the engine cooling cirsuit.

All these systems have drawbacks and weaknesses.

### SUMMARY OF THE INVENTION

It is an object of the invention to provide a supply device for an internal-combustion engine in which the liquid fuel is gasified and which enables the engine to be run with optimum efficiency and with as few harmful substances in the exhaust gases as possible.

In a first embodiment of the invention, this object is achieved with a supply device for an internal-combustion engine in which the fuel is gasified; this device comprises a container with fuel, an air inlet pipe fitted with an air diffuser submerged in the fuel, and a circuit for heating the fuel, comprising means for maintaining the temperature of the fuel at an optimum value.

In a first variant of the invention, the air diffuser has holes in its sides.

In another variant of the invention, the fuel heating circuit uses the engine cooling water.

In yet another variant of the invention, the means for maintaining the temperature of the fuel at an optimum value consist of a thermostat installed in the fuel heating circuit.

In yet another variant of the invention, the fuel heating system comprises a heating resistor.

In yet another variant of the invention, the optimum value of the temperature of the fuel in the container is maintained at an average value of 22° C. plus or minus a few degrees.

In yet another variant of the invention, the supply device for an internal-combustion engine comprises means for “drying” the air/fuel mixture.

In yet another variant of the invention, the supply device for an internal-combustion engine comprises a stabilizing means located above the air diffuser. This stabilizing means may consist of a layer of stainless-steel chips.

In a second embodiment of the invention, the object of the invention is also achieved with a supply device for an internal-combustion engine in which the fuel is gasified, the device comprising a container with fuel, a vacuum pump creating a vacuum in said container and drawing in the fuel gases which are released in the container while propelling these gases to an air/fuel mixer.

In a third embodiment of the invention, the object of the invention is also achieved with a kit for installing on an internal-combustion engine and comprising a supply device for an internal-combustion engine, this device comprising one or more of the features described above.

The invention also covers supply devices for an internal-combustion engine, comprising one or more combinations of the features described above.

### BRIEF DESCRIPTION OF THE FIGURES

FIG. 1 shows a device for gasifying a liquid fuel and for producing an improved air/fuel mixture.

FIG. 2 shows an intermediate means for connecting the device seen in FIG. 1 to the intake pipe of an engine.

FIG. 3 shows a variant of the device seen in FIG. 1, and

FIG. 4 shows schematically another variant of a device for gasifying a liquid fuel.

### DETAILED DESCRIPTION OF THE INVENTION

The invention is based on the principle of the gasification of a liquid fuel and the production of an optimum air/fuel mixture.

In the figures, identical parts are given the same reference numerals.

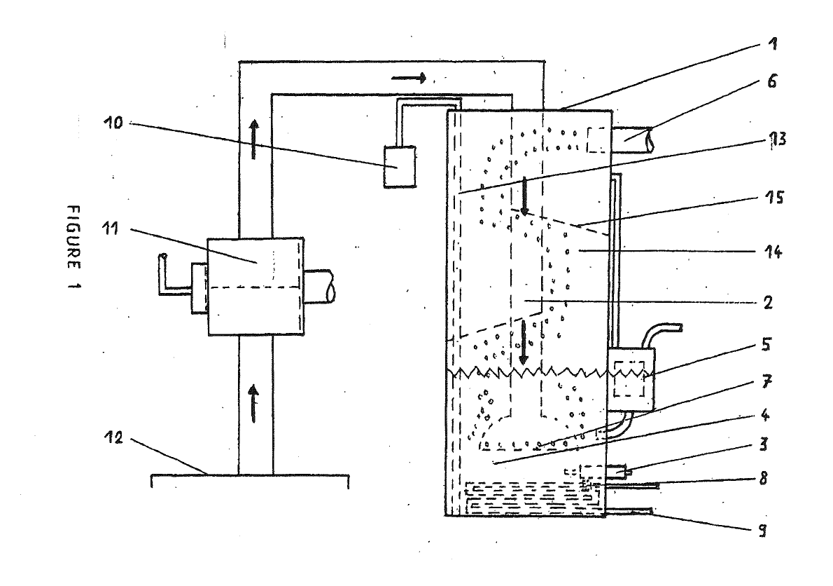

FIG. 1 shows a device for carrying out this principle according to the invention. This device comprises a container (1) containing liquid fuel (4). A constant-level apparatus (5) connected to the container (1) maintains the level of the fuel in the container (1) at a certain value. The constant-level apparatus (5) is connected to the container (1) from above to cancel out the effect of vacuum associated with operation. An air intake pipe (2) runs down into the container (1). At one end, this pipe takes air from the exterior, and at the other end is connected to an air diffuser (7), which is pierced with holes in the sides, the bottom of the diffuser being closed. There must be enough holes to allow the air to escape in sufficient quantities. The air diffuser (7) is installed in such a way that it is always submerged in the liquid fuel. In a preferred embodiment the external air is pre-heated by the exhaust system (12) before being sent to the air inlet pipe (2). In the air supply part, a valve controlled by thermostat (11) can supply the device with hot air or cold air, as required.

A takeoff from the engine cooling system (e.g. the coil 8, 9) through which the hot water can flow, enables the fuel to be heated. A thermostat (8) is used to maintain the temperature of the fuel at an optimum value, independently of the temperature of the cooling water.

A remote thermometer (thermometer 10 with sealed immersed probe 13) is used to measure the fuel temperature; this temperature can be indicated on the service panel or on the dashboard.

A heating resistor (3) makes it possible to heat the liquid fuel (4) on a cold startup to a defined temperature. Means of adjustment may also be provided to ensure a constant temperature of the fuel when heating with this resistor.

The air/fuel mixture leaves the container (1) via an outlet pipe (6).

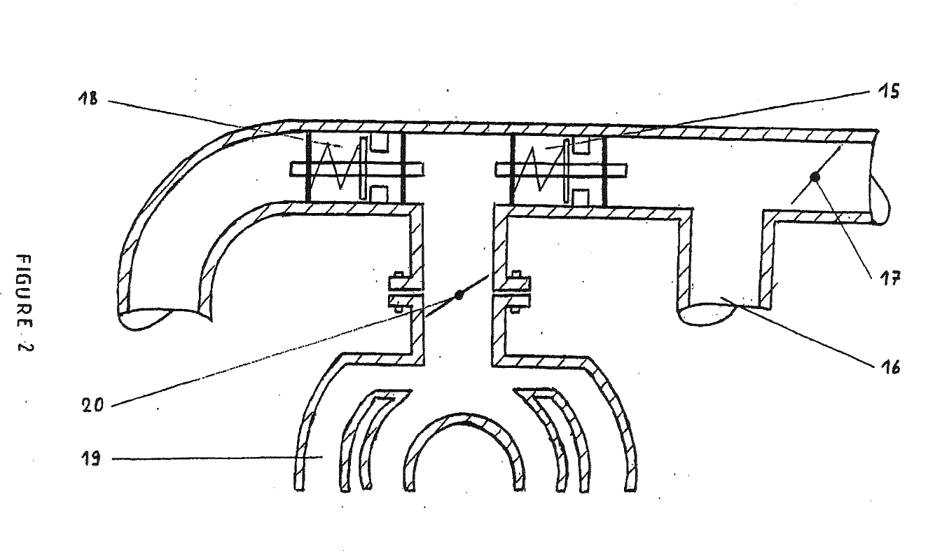

An intermediate means for connecting this outlet pipe (6) to the intake pipe (19) of an engine is illustrated in FIG. 2. This intermediate means comprises a supply intake (16) connected to the outlet pipe (6), e.g. by a hose. The intermediate means also comprises a vacuum intake butterfly valve (20) and a starter valve (17) connected by a cable to the starting motor of the vehicle.

The intermediate means also comprises a mechanical check valve (15) at the entrance of the intake pipe to protect the device from explosion in the event of auto-ignition. In this case a mechanical valve (18) located at the inlet opposite allows the pressure created by auto-ignition to be released.

Operation of the device shown in FIGS. 1 and 2 is as follows. When the cylinder, or one of the cylinders, of the engine is in the “admission” stroke, a vacuum is created in the container (1) via the pipe (6). Because of this vacuum, some of the fuel evaporates and the resulting gas is drawn in with external air, which arrives through the air diffuser (7). An optimum air/gasified fuel mixture is drawn into the cylinder in question, where the mixture will be ignited by an external ignition means (spark plug) or by auto-ignition, depending on how the engine works.

Evaporation of the fuel inside the container requires energy (calories) and, since the evaporation process is an adiabatic process, the fuel will be cooled. For this reason it is important to provide means for heating the fuel.

For optimum combustion of the air/fuel mixture, a stoichiometric proportion of air/fuel volumes is necessary. It has been found in practice that, in the case of a gasoline engine, optimum combustion of the mixture is obtained when the fuel has an average temperature of 22° C. plus or minus a few degrees. For this reason, a fuel temperature control circuit is provided, along with the thermostat (8). It should be stressed that the 22° C. value is an experimental value and that the optimum value for the temperature of the fuel may be influenced by certain factors such as the vacuum in the container, the type of fuel being used, the geometry of the container, etc.

Another condition for achieving good combustion of the mixture has to do with the fact that the percentage of particles of fuel in liquid form in the air/fuel mixture, drawn in by the cylinder, must be as low as possible and that the fuel present in the mixture must be practically completely in the gas state. This result is obtained by providing means for “drying” the mixture—that is, achieving maximum separation of the liquid parts (e.g. in the form of small droplets) from the mixture. To this end, partitions may be provided in the container (see in FIG. 1 the inclined partitions 15 mounted above the fuel, through which partitions the mixture travels). However, other means may also be used for this purpose, such as a droplet separator, a settling vessel, etc.

Advantageously a means of controlling the air/fuel mixture may also be provided by adding air when the mixture is too rich and reducing the air intake when the mixture is too lean.

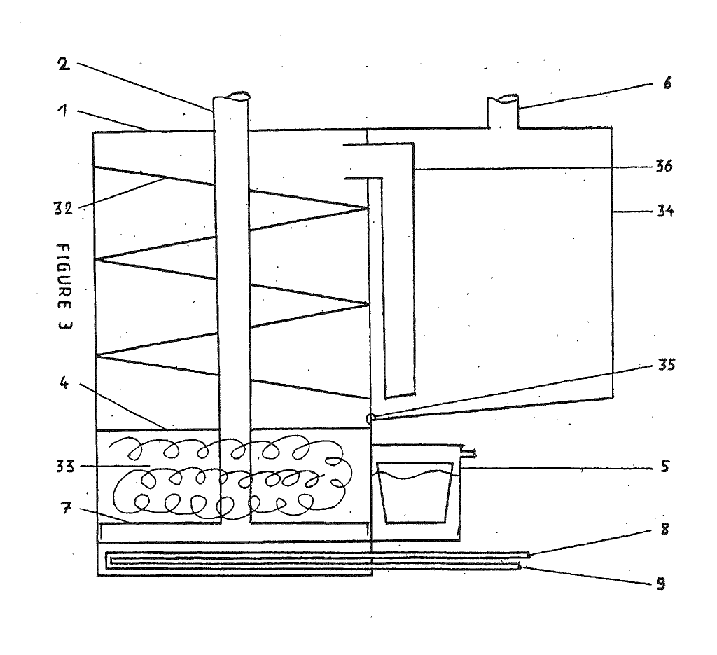

FIG. 3 shows a variant of the FIG. 1 device; certain features, such as the external air supply, are not shown here for reasons of simplification. In this FIG. 3, a container (1) is supplied with liquid fuel (4) through an apparatus (5) that maintains a constant level of liquid fuel. External air is drawn in through the pipe (2) and the air/fuel mixture is sent to the engine via the pipe (6). Above the perforated air diffuser (7) and within the fuel is a stabilizing means (33): this stabilizing means is highly porous (33) and has the feature of increasing the number of air bubbles in the fuel and at the same time stabilizing the upper surface of the liquid fuel so that it remains more or less stable—that is, horizontal during movements of the container, for example when cornering or when on slopes. A means that has proved highly effective is a layer of stainless steel chips, but a layer comprising one or more other materials is also possible. Another way of stabilizing the device is to have a universal-joint suspension of the container. In the embodiment shown in FIG. 3, the air/fuel mixture is “dried” by a helical passage (32) followed by a settling vessel (34). Inside the latter, liquid droplets are separated out by the angular movement applied to the air/fuel mixture inside a pipe (36). A small hole (35) at the bottom of the settling vessel (34) provides a return for liquid fuel to the container. Clearly, both the helical passage (32) and the settling vessel (34) can also be used separately for drying purposes, without the need to use a combination of both.

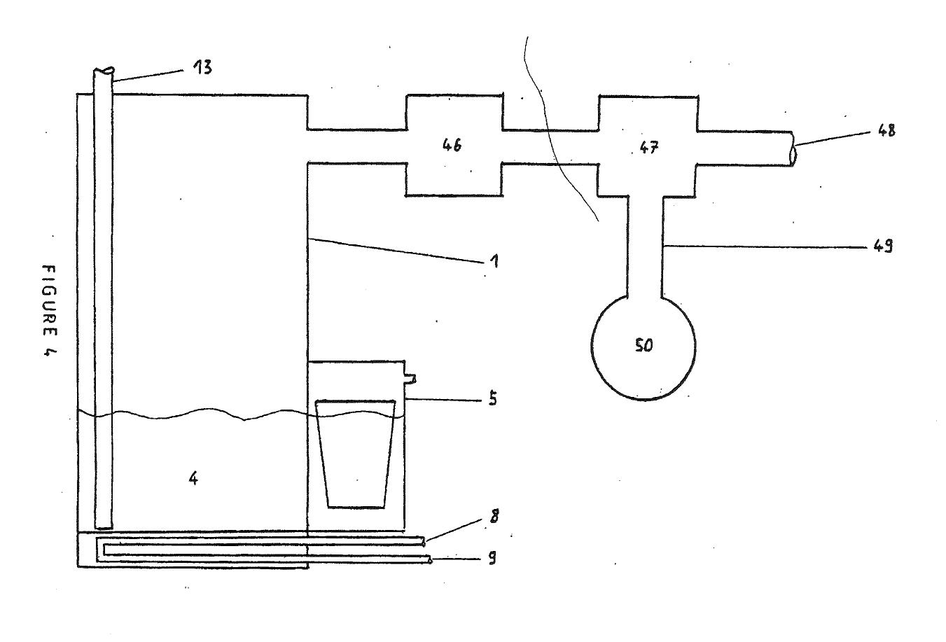

In the FIG. 4 embodiment, the container (1) merely acts as a means for gasifying the liquid fuel, while the creation of the air/fuel mixture is done later. The FIG. 4 device comprises a container (1) supplied with fuel through a constant-level maintenance apparatus (5) with a heating means (8, 9). A vacuum pump (46) connected to the container (1) produces a vacuum above the liquid fuel (4) and thus gasifies the fuel. The fuel gases are sent by the vacuum pump (46) to an air/fuel mixer (47), which is supplied with external air by a pipe (48). The air/fuel mixture is then forwarded to an internal-combustion engine (50) by another pipe (49).

The details of the control and adjustment are not shown in FIG. 4, but it is obvious that such control and adjustment means can be provided, such as those of the device shown in FIG. 1, or means familiar to those skilled in the art.

The container (1) can be the engine fuel tank, but it is preferably a separate tank, of suitable dimensions and location. The reason for this is that heating all of the fuel inside the engine fuel tank would reduce the fuel capacity of said tank, and it is also preferable to install the container (1) not too far from the engine. In addition, a conventional fuel tank is not suitable for use as a container for the device according to the invention.

It has been found that, by using the device according to the invention, the efficiency of internal-combustion engines can be raised to more than 60%, as compared with a normal efficiency of around 35 to 45%. This automatically results in a large reduction in exhaust gas pollutants and fuel consumption.

The supply device for an internal-combustion engine according to the invention can be original equipment, but the invention also provides kits comprising such a device for adapting existing engines to the new technology.

The invention can be applied to both gasoline and diesel engines and to engines that use biofuel (such as ethanol or rapeseed oil) or a blend of the various types of fuel.

In the case of diesel engines, especially existing diesel engines, there are various possible ways of adapting these engines to make them capable of using a device according to the invention. One possible way is to convert the diesel engine into a gasoline engine by modifying the compression ratio (a well-known technique) and fitting it with spark plugs. Another possible way involves combined operation with on one side the conventional diesel engine, idling, with, on the other side, a supply through a device according to the invention. What is more, the invention can be used on stationary engines (such as electricity generating sets) as well as on moving engines (cars, buses, trucks, boats, tractors). In the case of gasoline engines, the device according to the invention can replace the carburetor.

The invention is not limited to the embodiments as presented in the figures and described in the description above: rather, it also covers other embodiments which those skilled in the art may derive from these embodiments.

1. A supply device for an internal-combustion engine in which liquid fuel is gasified, comprising:
a container with fuel,
an air inlet pipe fitted with an air diffuser submerged in the fuel, and
a circuit for heating the fuel, comprising means for maintaining a temperature of the fuel at an optimum value.

2. The supply device for an internal-combustion engine as claimed in claim 1, wherein the air diffuser has holes in sides thereof.

3. The supply device for an internal-combustion engine as claimed in claim 1, wherein the fuel heating circuit uses engine cooling water.

4. The supply device for an internal-combustion engine as claimed in claim 1, wherein the means for maintaining the temperature of the fuel at an optimum value comprise a thermostat installed in the fuel heating circuit.

5. The supply device for an internal-combustion engine as claimed in claim 1, in which the fuel heating system comprises a heating resistor.

6. The supply device for an internal-combustion engine as claimed in claim 1, in which the optimum value at which the temperature of the fuel in the container is maintained is, on average, approximately 22° C.

7. The supply device for an internal-combustion engine as claimed in claim 1, further comprising means for drying the air/fuel mixture.

8. The supply device for an internal-combustion engine as claimed in claim 1, further comprising a stabilizing means located above the air diffuser.

9. The supply device for an internal-combustion engine as claimed in claim 8, in which the stabilizing means comprises a layer of stainless-steel chips.

10. A kit for installing on an internal-combustion engine and comprising a supply device for an internal-combustion engine as claimed in claim 1.
